(19) United States
(12) Patent Application Publication
(10) Pub. No.: US 2026/0272130 A1
(43) Pub. Date: Sep. 17, 2026

(54) Upper hub and electric sunshade umbrella including the same

(71) Applicant: Linhai Zhongtian Electronic Appliance co.,ltd, Taizhou (CN)

(72) Inventors: Shimin JIN, Taizhou (CN); Weijie WEI, Taizhou (CN); Longlong ZHAO, Taizhou (CN); Zhengtao SUN, Taizhou (CN); Xinglong TU, Taizhou (CN); Qianchao LU, Taizhou (CN); Xuexin CHEN, Taizhou (CN)

(21) Appl. No.: 19/653,508

(22) Filed: Apr. 21, 2026

(30) Foreign Application Priority Data
Apr. 23, 2025 (CN) 202520783454.4

(51) Int. Cl. A45B 25/14; F03D 3/00; F03D 9/00; F03D 9/25

(52) U.S. Cl. CPC A45B 25/143; F03D 3/005; F03D 9/007; F03D 9/25; A45B 2200/1027; A45B 2200/1036; F05B 2270/32; F05B 2270/809

(57) ABSTRACT

An upper hub, including a hub body and a pull cord driving mechanism. A mounting cavity is provided within the hub body. The pull cord driving mechanism is provided within the mounting cavity. An output end of the pull cord driving mechanism is connected to a winding mechanism. The pull cord driving mechanism is configured to drive the winding mechanism to rotate. The hub body is provided with a through hole. The winding mechanism is connected to a first end of an electric pull cord, and a second end of the electric pull cord is configured to pass through the through hole.

### CROSS-REFERENCE TO RELATED APPLICATIONS

This application claims the benefit of priority from Chinese Patent Application No. 202520783454.4, filed on Apr. 23, 2025. The content of the aforementioned application, including any intervening amendments made thereto, is incorporated herein by reference in its entirety.

### TECHNICAL FIELD

This application relates to sunshade umbrellas, and more particularly to an upper hub and an electric sunshade umbrella including the same.

### BACKGROUND

Sunshade umbrellas, also known as parasols, are mainly used to block direct sunlight. They are commonly used in summer and can effectively protect the skin from ultraviolet radiation. Most of the existing commercially-available sunshade umbrellas are manually operated, and some electric sunshade umbrellas have emerged with the development of technology.

Chinese patent No. 218942467U discloses a manual-automatic integrated electric umbrella, which includes a main body, an electric opening and closing mechanism, a manual opening and closing mechanism and a control mechanism. The main body includes a canopy, a pole, a plurality of first ribs, an upper hub, a lower hub and a plurality of second ribs. The electric opening and closing mechanism is fixed to a lower end of the upper hub, and includes a driving motor and an electric pull cord. The driving motor is drivably connected to a first end of the electric pull cord, and is configured to control winding of the electric pull cord, and a second end of the electric pull cord is detachably connected to the lower hub. The driving motor is electrically connected to the control mechanism. The manual opening and closing mechanism includes a manual crank and a manual pull cord. The manual crank is connected to a first end of the manual pull cord, and is configured to control winding of the manual pull cord, and a second end of the manual pull cord is detachably connected to the lower hub. Electric and manual operations are integrated, such that when the electric opening and closing mechanism fails, the main body can still be controlled by means of the manual opening and closing mechanism.

However, in the above-mentioned patent, the upper hub and the electric opening and closing mechanism are designed into separate structures, which not only results in high structural complexity, but also increases manufacturing costs as well as the complexity of assembly and disassembly. Moreover, the multi-segment connection structure reduces the connection strength at an upper end of the umbrella shaft.

Therefore, there is an urgent need for a novel upper hub and an electric sunshade umbrella to solve the above-mentioned problems.

### SUMMARY

An object of the present disclosure is to provide an upper hub and an electric sunshade umbrella including the same, in which a driving motor is integrated into the upper hub, thereby simplifying the structure and enhancing the strength of the electric sunshade umbrella.

Technical solutions of the present disclosure are described as follows.

In a first aspect, this application provides an upper hub, comprising:
a hub body; and
a pull cord driving mechanism;
wherein a mounting cavity is provided within the hub body;
the pull cord driving mechanism is provided within the mounting cavity;
an output end of the pull cord driving mechanism is connected to a winding mechanism;
the pull cord driving mechanism is configured to drive the winding mechanism to rotate;
the hub body is provided with a first through hole; and
the winding mechanism is connected to a first end of an electric pull cord, and a second end of the electric pull cord is configured to pass through the first through hole.

In some embodiments, the winding mechanism is a winding shaft; and an end of the winding shaft is connected to the output end of the pull cord driving mechanism.

In some embodiments, the pull cord driving mechanism comprises a driving motor and a self-locking transmission mechanism;
an output shaft of the driving motor is connected to an input shaft of the self-locking transmission mechanism; and
an output shaft of the self-locking transmission mechanism is drivably connected to the winding shaft.

In some embodiments, the upper hub further comprises a support fixing member;
wherein the support fixing member is mounted on a side of the self-locking transmission mechanism;
the support fixing member is provided with a limiting hole; and
an end of the winding shaft away from the self-locking transmission mechanism is rotatably connected to the limiting hole.

In some embodiments, the hub body comprises a hub seat and a hub cover assembly; and the hub seat is fixedly connected to the hub cover assembly.

In some embodiments, a plurality of housing portions are circumferentially arranged spaced apart on the hub seat, and are configured to protrude outwardly;
a rib mounting gap is formed between any two adjacent housing portions among the plurality of housing portions;
the rib mounting gap is configured for rotatable connection with a first rib;
two sides of each of the plurality of housing portions are each provided with a coil slot; and
a rib coil is jointly mounted on all coil slots;
a central portion of the hub seat is provided with an accommodating cavity; and
a lower end of the driving motor is inserted into the accommodating cavity.

In some embodiments, the hub cover assembly comprises a first hub cover and a second hub cover;
the first hub cover is closer to the hub seat than the second hub cover;
a plurality of wire-passing holes are circumferentially arranged spaced apart on the first hub cover;
the second hub cover is provided with a second through hole and a third through hole;
the driving motor is configured to pass through the second through hole; and
the control mechanism is configured to pass through the third through hole.

In some embodiments, an upper end of the hub cover assembly is provided with a wind force monitoring mechanism;
the wind force monitoring mechanism comprises a fan housing;
a plurality of ventilation holes are circumferentially arranged spaced apart at the fan housing;
an upper end of the fan housing is connected to a fan cover;
a fan is provided within the fan housing;
the fan comprises a blade holder;
the blade holder is rotatably connected to the fan housing;
a plurality of blades are circumferentially arranged spaced evenly apart on the blade holder; and
the fan is electrically connected to the control mechanism via a wind energy conversion mechanism.

In some embodiments, an upper end of the wind force monitoring mechanism is provided with a solar photovoltaic assembly; and the solar photovoltaic assembly is electrically connected to the control mechanism.

In some embodiments, the blade holder is provided with transmission external teeth; a lower end of the fan housing is provided with a mounting groove; the wind energy conversion mechanism comprises a transmission gear and a generator; the transmission gear is mounted on an input shaft of the generator; the transmission gear is configured to mesh with the transmission external teeth; and is mounted in the mounting groove, and the generator is electrically connected to the control mechanism; or
the blade holder is connected to a shielding plate; the wind energy conversion mechanism comprises a U-shaped photoelectric switch; the shielding plate is configured to rotate to pass through the U-shaped photoelectric switch; and the U-shaped photoelectric switch is electrically connected to the control mechanism.

In some embodiments, the winding mechanism is a winch; and a first side of the winch is connected to the output end of the pull cord driving mechanism.

In some embodiments, the first side of the winch is provided with an insertion hole; and the output end of the pull cord driving mechanism is inserted into the insertion hole.

In some embodiments, the output end of the pull cord driving mechanism is in a form-fit connection with the insertion hole.

In some embodiments, the upper hub further comprises a support fixing member;
wherein the support fixing member is provided with a limiting hole; and
a second side of the winch is configured to partially extend into the limiting hole.

In some embodiments, a washer is provided in the limiting hole; and the washer is configured to rotatably abut against the second side of the winch.

In some embodiments, the winch is provided with a fastening hole; and the fastening hole is connected to the first end of the electric pull cord.

In some embodiments, a central portion of the fan housing is provided with a mounting ring; a bearing is sleeved on the mounting ring; and the fan is rotatably mounted on the mounting ring via the bearing.

In some embodiments, the wind energy conversion mechanism comprises a magnetic member and a sensor;
the magnetic member is provided on the fan; and
the sensor is arranged opposite to the magnetic member in a vertical direction.

In some embodiments, the sensor is mounted on the hub cover assembly via a mounting plate.

In a second aspect, this application provides an electric sunshade umbrella, comprising:
the upper hub described above;
a lower hub;
a pole;
a plurality of first ribs;
a plurality of second ribs;
a canopy; and
a control switch;
wherein the upper hub is fixed to an upper end of the pole;
the lower hub is slidably connected to the pole;
the lower hub is provided with a cord attachment;
the second end of the electric pull cord is connected to the cord attachment;
the number of the plurality of first ribs is the same as the number of the plurality of second ribs;
an end of each of the plurality of first ribs is hinged to the upper hub;
a first end of each of the plurality of second ribs is hinged to a corresponding one of the plurality of first ribs, and a second end of each of the plurality of second ribs is hinged to the lower hub;
the canopy is mounted on the plurality of the first ribs; and
the control switch is mounted to the pole, and is electrically connected to the control mechanism.

Compared to the prior art, the present disclosure has the following beneficial effects.

In the present disclosure, the driving motor is integrated into the upper hub, such that no additional structure is required to accommodate the driving motor, thereby achieving optimization in terms of structural configuration, manufacturing cost, and ease of assembly and disassembly. In addition, since an upper end of the electric sunshade umbrella is directly connected only to the upper hub, the overall structural strength of the electric sunshade umbrella is also improved.

### BRIEF DESCRIPTION OF THE DRAWINGS

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a perspective view of an upper hub according to Embodiment 1 of the present disclosure;

FIG. 2 is a cross-sectional view of the upper hub according to Embodiment 1 of the present disclosure;

FIG. 3 is an exploded view of the upper hub according to Embodiment 1 of the present disclosure, from a top view;

FIG. 4 is an exploded view of the upper hub according to Embodiment 1 of the present disclosure, from a bottom view;

FIG. 5 is a structural diagram of a hub seat of the upper hub according to Embodiment 1 of the present disclosure;

FIG. 6 structurally depicts a first hub cover of the upper hub according to Embodiment 1 of the present disclosure;

FIG. 7 structurally depicts a second hub cover of the upper hub according to Embodiment 1 of the present disclosure;

FIG. 8 is a structural view of a fan housing of the upper hub according to Embodiment 1 of the present disclosure;

FIG. 9 is a structural view of a fan of the upper hub according to Embodiment 1 of the present disclosure;

FIG. 10 is a structural view of a support fixing member of the upper hub according to Embodiment 1 of the present disclosure;

FIG. 11 is a cross-sectional view of an upper hub according to Embodiment 2 of the present disclosure;

FIG. 12 is an exploded view of the upper hub according to Embodiment 2 of the present disclosure, viewed from a top perspective;

FIG. 13 is an exploded view of the upper hub according to Embodiment 2 of the present disclosure, viewed from a bottom perspective;

FIG. 14 is a first perspective view of an electric sunshade umbrella according to Embodiment 3 of the present disclosure;

FIG. 15 is a second perspective view of the electric sunshade umbrella according to Embodiment 3 of the present disclosure;

FIG. 16 is a perspective view of the electric sunshade umbrella according to Embodiment 3 of the present disclosure without a canopy;

FIG. 17 is an exploded view of a winding mechanism of the upper hub according to Embodiment 1 of the present disclosure;

FIG. 18 is a structural diagram of a wind energy conversion mechanism of the upper hub according to Embodiment 1 of the present disclosure;

FIG. 19 is a cross-sectional view of the upper hub according to Embodiment 1 of the present disclosure; and

FIG. 20 is a cross-sectional view of the winding mechanism of the upper hub according to Embodiment 1 of the present disclosure.

In the figures: 1—hub seat; 101—housing portion; 102—coil slot; 103—rib mounting gap; 104—first accommodating cavity; 105—electric pull cord; 106—first through hole; 2—first hub cover; 201—wire-passing hole; 3—second hub cover; 301—second through hole; 302—second accommodating cavity; 303—third through hole; 4—driving motor; 41—motor mounting bracket; 411—first avoidance notch; 412—first fixing plate; 413—second fixing plate; 42—winch; 421—rotary shaft; 422—baffle; 4211—insertion hole; 4212—fastening hole; 5—winding shaft; 6—fan housing; 61—mounting ring; 62—second bearing; 63—magnetic member; 64—sensor; 641—lead wire; 65—mounting plate; 601—ventilation hole; 602—mounting groove; 7—fan; 701—blade holder; 702—blade; 703—transmission external teeth; 8—fan cover; 81—umbrella cover; 9—solar photovoltaic assembly; 10—main control circuit board; 11—lighting control circuit board; 12—self-locking transmission mechanism; 13—support fixing member; 1301—limiting hole; 1302—first support plate; 1303—second support plate; 1304—third support plate; 1305—fourth through hole; 1306—lifting hole; 1307—second avoidance notch; 14—first bearing; 15—transmission gear; 16—generator; 17—U-shaped photoelectric switch; 18—shielding plate; 100—upper hub; 200—lower hub; 300—pole; 400—first rib; 500—second rib; 600—canopy; and 700—control switch.

### DETAILED DESCRIPTION OF EMBODIMENTS

The present disclosure will be clearly and completely described below with reference to the embodiments and accompanying drawings. Obviously, described herein are merely some embodiments of the present disclosure, rather than all embodiments. Based on the embodiments provided herein, all other embodiments obtained by those of ordinary skill in the art without making creative effort shall fall within the scope of the present disclosure.

An embodiment of the present disclosure provides an upper hub and an electric sunshade umbrella including the same, in which a driving motor is integrated into the upper hub, thereby simplifying the structure and enhancing the strength of the electric sunshade umbrella.

In order to more clearly illustrate the above-described objects, features and advantages of the present disclosure, the present disclosure will be further described in detail below with reference to the accompanying drawings and the embodiments.

### Embodiment 1

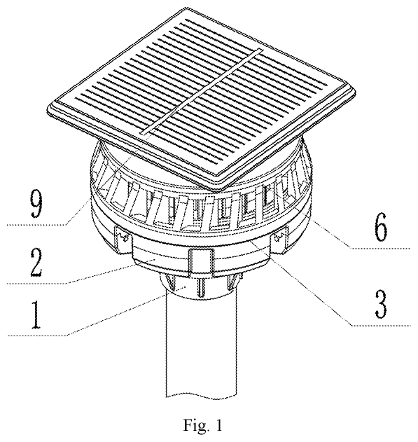

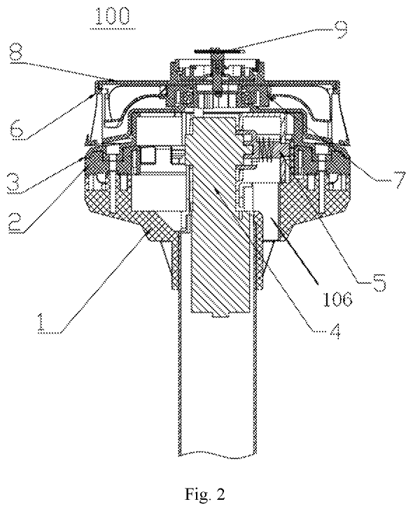

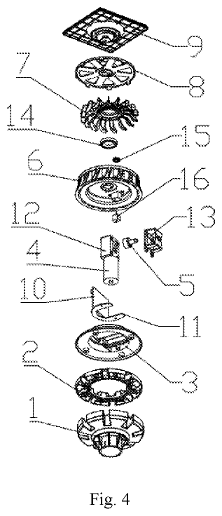

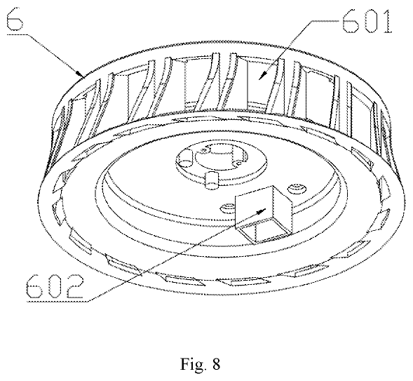

As shown in FIGS. 1-10, provided herein is an upper hub 100, including a hub body and a pull cord driving mechanism. A mounting cavity is provided within the hub body. The pull cord driving mechanism is provided within the mounting cavity. An output end of the pull cord driving mechanism is connected to a winding mechanism. The pull cord driving mechanism is configured to drive the winding mechanism to rotate. The winding mechanism is connected to a first end of an electric pull cord 105.

A second end of the electric pull cord 105 is connected to a lower hub 200 of the electric sunshade umbrella, so as to enable winding and unwinding of the electric pull cord 105 through forward and reverse rotation of the winding mechanism, thereby driving the lower hub 200 to move upward and downward along a pole 300, and finally completing opening and closing operations of the sunshade umbrella.

In an embodiment, the winding mechanism is a winding shaft 5. The output end of the pull cord driving mechanism is connected to the winding shaft 5. When the pull cord driving mechanism is actuated, the pull cord driving mechanism drives the winding shaft 5 to rotate. The winding shaft 5 is connected to the first end of the electric pull cord 105. Specifically, the winding shaft 5 is provided with a pull cord fixing hole for securing the first end of the electric pull cord 105, and the electric pull cord 105 is partially wound around the winding shaft 5. The second end of the electric pull cord 105 is connected to the lower hub 200. The hub body is provided with a first through hole 106. The second end of the electric pull cord 105 (i.e., an end away from the winding shaft 5) is configured to pass through the first through hole 106. With this arrangement, the electric pull cord 105 is provided outside the upper hub 100 or the pole 300, rather than occupying internal space of the upper hub 100 and the pole 300, such that the internal space of the upper hub 100 and the pole 300 can be fully used for routing electrical wires. In addition, the pull cord driving mechanism is electrically connected to a control mechanism. The control mechanism is configured to control operation of the pull cord driving mechanism. The control mechanism may be provided within the hub body, or may alternatively be provided at another location of the electric sunshade umbrella.

In practical use, the control mechanism controls forward and reverse rotation of the pull cord driving mechanism, thereby winding and unwinding the electric pull cord 105. As the electric pull cord 105 is wound and unwound, the second end of the electric pull cord 105 drives the lower hub 200 to move upward and downward along the pole 300, thereby achieving opening and closing of the electric sunshade umbrella. In this embodiment, the pull cord driving mechanism is integrated into the upper hub 100, thereby simplifying the overall structure, reducing manufacturing cost, and improving the strength of the pole 300 of the electric sunshade umbrella.

The hub body includes a hub seat 1, a hub cover assembly, the pull cord driving mechanism and the control mechanism. The hub seat 1 is fixedly connected to the hub cover assembly. The hub cover assembly is provided at an upper end of the hub seat 1. A lower end of the hub seat 1 is connected to the pole 300. The mounting cavity is provided within the hub seat 1 and the hub cover assembly.

The pull cord driving mechanism and the control mechanism are both provided within the mounting cavity. The control mechanism includes a main control circuit board 10 and associated electronic components, and is electrically connected to a driving motor 4. The control mechanism is configured to receive external control signals and control start and stop, forward and reverse rotation, and rotational speed of the driving motor 4, thereby precisely controlling a length and speed of winding and unwinding of the electric pull cord 105.

In this embodiment, the pull cord driving mechanism includes the driving motor 4 and a self-locking transmission mechanism 12. An output shaft of the driving motor 4 is connected to an input shaft of the self-locking transmission mechanism 12. An output shaft of the self-locking transmission mechanism 12 is drivably connected to the winding shaft 5. Specifically, the self-locking transmission mechanism 12 is drivably connected to the winding shaft 5 via a coupling. In some embodiments, an end of the winding shaft 5 is provided with a recess matched to the output shaft of the self-locking transmission mechanism 12, such that the output shaft of the self-locking transmission mechanism 12 is directly inserted into the recess, or is connected via a key.

The self-locking transmission mechanism 12 may adopt an existing speed reducer having a self-locking function, such as a conventional worm gear reducer. Those skilled in the art may also replace the self-locking transmission mechanism 12 with other components or assemblies capable of transmission connection, as long as the power from the output shaft of the driving motor 4 can be transmitted to the winding shaft 5 to drive the winding shaft 5 to rotate.

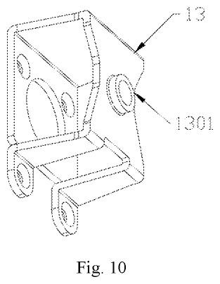

In this embodiment, as shown in FIG. 10, the hub body further includes a support fixing member 13. The support fixing member 13 has a rectangular housing structure, and four connecting holes are provided at four corners of the support fixing member 13. A side surface of the self-locking transmission mechanism 12 corresponding to the support fixing member 13 is provided with four threaded holes. The support fixing member 13 is mounted to a side of the self-locking transmission mechanism 12 by screws. The support fixing member 13 is provided with a limiting hole 1301. An end of the winding shaft 5 away from the self-locking transmission mechanism 12 is rotatably connected to the limiting hole 1301. This arrangement can prevent excessive vibration of the winding shaft 5 during rotation, thereby ensuring stable operation of the upper hub 100.

In this embodiment, the hub body includes the hub seat 1 and the hub cover assembly. The hub seat 1 is fixedly connected to the hub cover assembly. Specifically, the hub seat 1 and the hub cover assembly may be integrally formed, or may be separate structures and subsequently fixedly connected by screws or other fastening means. The hub cover assembly is provided at the upper end of the hub seat 1. The lower end of the hub seat 1 is connected to the pole 300. The mounting cavity as described above is formed within the hub seat 1 and the hub cover assembly.

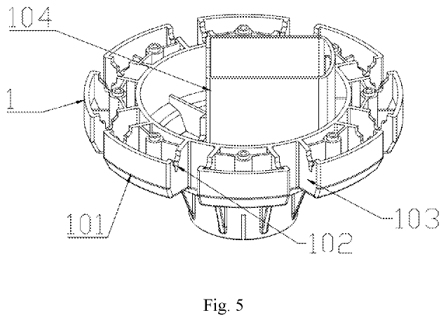

In this embodiment, as shown in FIG. 5, a plurality of fan-shaped housing portions 101 are circumferentially arranged spaced apart on the hub seat 1, and are configured to protrude outwardly. A rib mounting gap 103 is formed between any two adjacent housing portions 101 among the plurality of housing portions 101. The rib mounting gap 103 is configured for rotatable connection with a first rib 400. As shown in FIG. 5, two sides of each housing portion 101 are each provided with a coil slot 102. A rib coil is jointly mounted on all coil slots 102. The rib coil is an iron ring. Specifically, a circular rib coil sequentially passes through corresponding through holes of the first ribs 400, so that the first ribs 400 and the rib coil are capable of relative rotation. The rib coil is then placed into the corresponding coil slots 102.

A central portion of the hub seat 1 is provided with a first accommodating cavity 104. A lower end of the driving motor 4 is inserted into the first accommodating cavity 104 for fixing the driving motor 4.

In this embodiment, the hub cover assembly includes a first hub cover 2 and a second hub cover 3. The first hub cover 2 is closer to the hub seat 1 than the second hub cover 3, i.e., the first hub cover 2 is located between the second hub cover 3 and the hub seat 1.

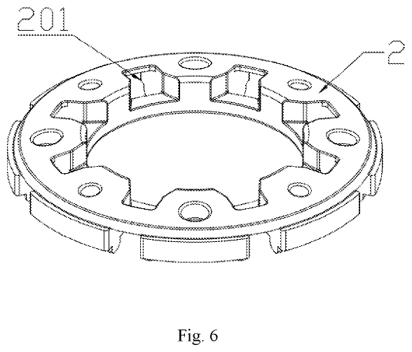

As shown in FIG. 6, the first hub cover 2 has a circular disk-shaped structure. A plurality of wire-passing holes 201 are circumferentially arranged spaced apart on the first hub cover 2. The wire-passing holes 201 are configured for allowing electrical wires inside the pole 300 or the ribs to pass through.

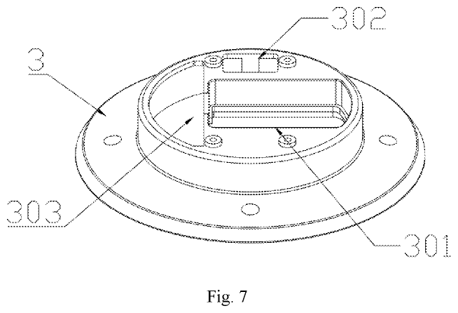

As shown in FIG. 7, the second hub cover 3 has a disk-shaped structure. The second hub cover 3 is provided with a second through hole 301 and a third through hole 303. An upper end of the driving motor 4 is configured to extend upward through the second through hole 301.

In this regard, as shown in FIG. 5, eight housing portions 101 are provided on the hub seat 1. A connecting column is formed at a central portion of each housing portion 101. An upper end of the connecting column is provided with a connecting threaded hole. Correspondingly, as shown in FIG. 6, eight first connecting holes are circumferentially arranged spaced evenly apart on the first hub cover 2. The first connecting holes on the first hub cover 2 are alternately arranged with the wire-passing holes 201. The first connecting holes are in one-to-one correspondence with the eight connecting threaded holes on the hub seat 1. Further, as can be seen from FIG. 6, the eight first connecting holes on the first hub cover 2 have different diameters. In the orientation shown in FIG. 6, the first connecting holes on the first hub cover 2 are divided into two groups. A first group includes the holes located at the top, bottom, left and right positions in FIG. 6, and a second group includes the holes located at the upper-left, lower-left, upper-right, and lower-right positions. The diameter of the holes in the first group is larger than that of the second group. Similarly, the connecting threaded holes on the hub seat 1 are also divided into two groups in the same orientation. As shown in FIG. 7, four second connecting holes are provided on the second hub cover 3, located at the top, bottom, left, and right positions, which correspond to the first-group first connecting holes on the first hub cover 2 and the first-group connecting threaded holes on the hub seat 1. In actual assembly, the first hub cover 2 is first connected to the hub seat 1 using the second-group holes, and screws are sequentially used to connect the second-group first connecting holes of the first hub cover 2 with the second-group connecting threaded holes of the hub seat 1, thereby fixing the first hub cover 2 and the hub seat 1. At this stage, electrical wires inside the pole 300, first ribs 400 and second ribs 500 are arranged and sequentially passed through the corresponding wire-passing holes 201. After the wiring is completed, four screws are used to sequentially pass through the four second connecting holes of the second hub cover 3, the four first-group first connecting holes of the first hub cover 2, and the four first-group connecting threaded holes of the hub seat 1, thereby fixing the second hub cover 3, the first hub cover 2 and the hub seat 1 together.

After the second hub cover 3, the first hub cover 2 and the hub seat 1 are fixed, the control mechanism is allowed to pass through the third through hole 303 and be placed into the mounting cavity.

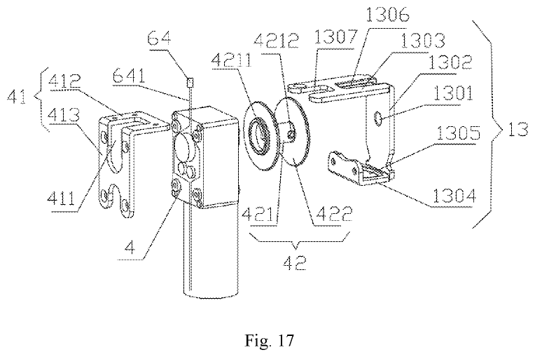

As shown in FIG. 17, in some embodiments, the winding mechanism is a winch 42. A first side of the winch 42 is connected to an output end of the pull cord driving mechanism.

In this embodiment, the winch 42 includes a rotary shaft 421 and two baffles 422. The two baffles 422 are fixedly sleeved at two ends of the rotary shaft 421. A winding groove for winding the electric pull cord is formed between the two baffles 422. The winding groove enables the electric pull cord to be neatly arranged during winding, thereby preventing entanglement or stacking of the electric pull cord, ensuring smooth winding and unwinding of the electric pull cord, and further improving operational stability of the electric sunshade umbrella. Meanwhile, the baffles 422 can limit the position of the electric pull cord, preventing the electric pull cord from slipping off two sides of the rotary shaft 421 during winding or unwinding.

Specifically, a first end of the rotary shaft 421 is provided with an insertion hole 4211. The output end of the pull cord driving mechanism is inserted into the insertion hole 4211. The rotary shaft 421 is coaxially arranged with the output end of the pull cord driving mechanism. The output end of the pull cord driving mechanism is in a form-fit connection with the insertion hole 4211, which may adopt a square shaft and a hexagonal shaft. Through such form-fit connection, torque from the output end of the pull cord driving mechanism can be stably and efficiently transmitted to the winch 42, thereby further ensuring safe operation of the winding mechanism.

The winch 42 is provided with a fastening hole 4212. The fastening hole 4212 is connected to the first end of the electric pull cord 105. Specifically, the fastening hole 4212 is formed in the rotary shaft 421 between the two baffles 422.

In this embodiment, the upper hub further includes the support fixing member 13. The support fixing member 13 is provided with the limiting hole 1301. A second end of the rotary shaft 421 is configured to extend into the limiting hole 1301. By providing the limiting hole 1301, stable support is formed at a second side of the winch 42, thereby effectively preventing the winch 42 from wobbling or deviating due to uneven loading during rotation, thereby further improving coaxial alignment and operational stability of the winch 42.

Specifically, the support fixing member 13 includes a first support plate 1302, a second support plate 1303 and a third support plate 1304. Two ends of the first support plate 1302 are respectively connected to an end of the second support plate 1303 and an end of the third support plate 1304, such that the first support plate 1302, the second support plate 1303 and the third support plate 1304 jointly form a substantially C-shaped structure. The limiting hole 1301 is formed in the first support plate 1302.

The third support plate 1304 is provided with a fourth through hole 1305. After passing through the fourth through hole 1305, the second end of the electric pull cord 105 is connected to the lower hub 200 of the electric sunshade umbrella.

Two ends of the second support plate 1303 are provided with a lifting hole 1306 and a second avoidance notch 1307, respectively. An end of the second support plate 1303 away from the first support plate 1302 is fixedly connected to an upper end of the pull cord driving mechanism by bolts. The lifting hole 1306 is configured, on one hand, to allow a hand to be inserted therethrough when the pull cord driving mechanism needs to be removed, thereby providing a force application point for fingers; and on the other hand, to provide a clearance space above the winch 42 so that more pull cord can be wound. The second avoidance notch 1307 is configured to avoid interference with other components on the pull cord driving mechanism when the second support plate 1303 is connected to the pull cord driving mechanism.

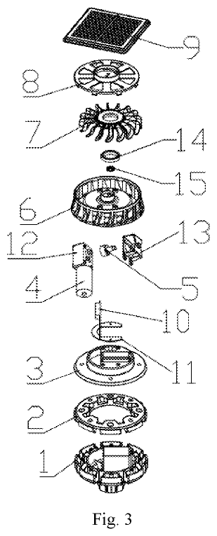

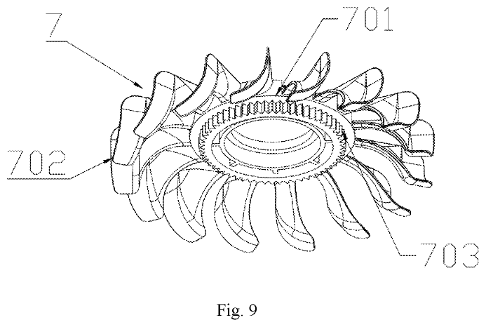

In this embodiment, an upper end of the hub cover assembly is provided with a wind force monitoring mechanism. The wind force monitoring mechanism is configured to detect wind strength and feed the detected information back to the control mechanism, so as to determine whether the driving motor 4 should operate. The wind force monitoring mechanism includes a fan housing 6. The fan housing 6 is a frame structure. A central portion of the fan housing 6 is provided with a horizontally arranged circular plate. A plurality of ventilation holes 601 are circumferentially arranged spaced apart at the fan housing 6, such that external air can enter an interior of the fan housing 6 through the ventilation holes 601. An upper end of the fan housing 6 is connected to a fan cover 8 by snap-fit or threaded connection. A fan 7 is provided within the fan housing 6. The fan 7 includes a blade holder 701. As shown in FIGS. 3 and 9, a central portion of an upper surface of the blade holder 701 is provided with a connecting cylinder. The connecting cylinder of the blade holder 701 is rotatably connected to the fan housing 6 via a first bearing 14. The first bearing 14 is a rotary bearing. An inner ring of the first bearing 14 is fixedly connected to an outer wall of the connecting cylinder, and an outer ring of the first bearing 14 is connected to a fifth through hole of the blade holder 701. A plurality of blades 702 are circumferentially arranged spaced evenly apart on the blade holder 701. When external air enters the fan housing 6 through the ventilation holes 601, the blades 702 are driven to rotate. The fan 7 is electrically connected to the control mechanism through a wind energy conversion mechanism. When the blades 702 rotate, wind-related information is transmitted to the control mechanism via the wind energy conversion mechanism. When the wind strength is relatively high, the control mechanism controls the driving motor 4 to release a portion of the electric pull cord 105, such that the lower hub 200 moves downward under its own weight, thereby closing the electric sunshade umbrella.

In this embodiment, an upper end of the wind force monitoring mechanism is provided with a solar photovoltaic assembly 9. The solar photovoltaic assembly 9 is of a conventional configuration and includes a solar photovoltaic panel and a storage battery. The solar photovoltaic panel is electrically connected to the storage battery. Further, a connection wire between the solar photovoltaic panel and the storage battery is provided with a micro-inverter. These are all mature, well-known technologies, and thus detailed structures and operating principles thereof are not described herein. The storage battery of the solar photovoltaic assembly 9 is electrically connected to the control mechanism so as to supply power to the control mechanism. In addition, the storage battery may also be electrically connected to the driving motor 4 to provide electric power. As for an installation position of the storage battery, it may be provided within the mounting cavity of the upper hub 100. Alternatively, those skilled in the art may arrange the storage battery on the lower hub 200 or the pole 300. The installation position is not limited and may be selected according to actual sizes of the storage battery and the electric sunshade umbrella.

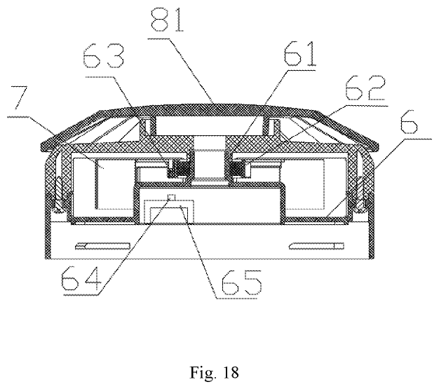

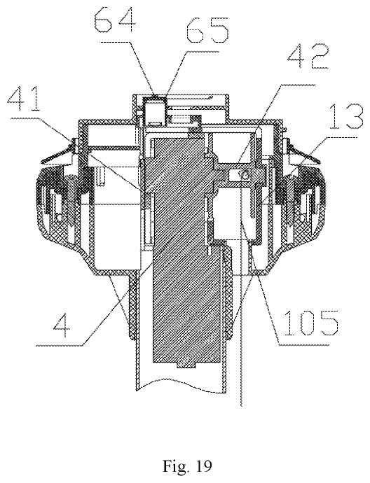

As shown in FIGS. 18-19, in some embodiments, a central portion of the fan housing 6 is provided with a mounting ring 61. A second bearing 62 is sleeved in the mounting ring 61. The fan 7 is rotatably mounted on the mounting ring 61 via the second bearing 62.

An inner circumferential wall of the mounting ring 61 is in an interference fit with an outer ring of the second bearing 62. An inner ring of the second bearing 62 is in a press fit with a rotating shaft of the fan 7. The provision of the second bearing 62 effectively reduces frictional resistance during rotation of the fan 7, improves smoothness and flexibility of rotation, reduces noise and component wear caused by friction, and prolongs service life of the fan 7.

In an embodiment, the wind energy conversion mechanism includes a magnetic member 63 and a sensor 64. The magnetic member 63 is mounted on the fan 7. The sensor 64 is arranged opposite to the magnetic member 63 in a vertical direction. The sensor 64 is mounted on the hub cover assembly via a mounting plate 65.

In this embodiment, the magnetic member 63 may be a permanent magnet, which is fixedly mounted on the rotating shaft or a blade root of the fan 7 so as to rotate synchronously with the fan 7. The sensor 64 is correspondingly configured as a Hall sensor. A sensing surface of the Hall sensor is oriented toward the magnetic member 63. When the magnetic member 63 passes directly below the Hall sensor as the fan rotates, the Hall sensor generates a pulse signal due to a change in magnetic field. The sensor 64 is electrically connected to the control mechanism via a signal line, and transmits the pulse signal to the control mechanism in real time. The control mechanism determines a rotational speed of the fan by calculating the number of pulse signals received per unit time, and further determines a wind force level according to a predefined correspondence between rotational speed and wind force.

In an embodiment, as shown in FIGS. 17 and 19, a side of the driving motor 4 away from the winding mechanism is provided with a motor mounting bracket 41. A gap is formed between the motor mounting bracket 41 and the driving motor 4. The motor mounting bracket 41 is provided with a first avoidance notch 411.

In this embodiment, the motor mounting bracket 41 has an inverted L-shaped structure. The first avoidance notch 411 is configured to avoid interference with a lead wire 641 of the sensor 64. Specifically, the lead wire 641 of the sensor 64 is arranged between the motor mounting bracket 41 and the driving motor 4. The motor mounting bracket 41 and the driving motor 4 jointly protect the lead wire 641 of the sensor 64, preventing failure of the sensor 64 caused by compression of the lead wire 641. The lead wire 641 of the sensor 64 passes through the gap, extends through the first avoidance notch 411, and is then connected to the sensor 64.

The motor mounting bracket 41 includes a first fixing plate 412 and a second fixing plate 413. An end of the first fixing plate 412 is connected to an end of the second fixing plate 413 to form an L-shaped structure. The first avoidance notch 411 is formed at a bent connection portion between the first fixing plate 412 and the second fixing plate 413. Two ends of the first avoidance notch 411 are respectively configured to extend through the first fixing plate 412 and the second fixing plate 413.

In addition, if the solar photovoltaic assembly 9 is not provided, a battery compartment may be arranged, and common dry batteries may be used to supply power to the control mechanism and the driving motor 4. Alternatively, a charging cable may be directly connected to a mains power source to provide power to the electric sunshade umbrella.

It should be noted that, according to customer customization requirements, in some embodiments, an umbrella cover 81 or the solar photovoltaic assembly 9 may be provided on the fan cover 8.

As shown in FIG. 18, in an embodiment in which the winding mechanism of the upper hub is the winch 42, the umbrella cover 81 is provided on the fan cover 8.

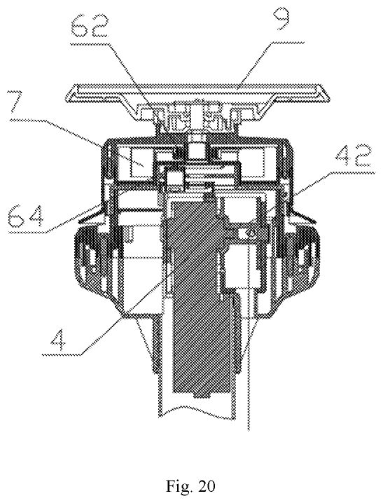

As shown in FIG. 20, in an embodiment in which the winding mechanism of the upper hub is the winch 42, the solar photovoltaic assembly 9 is provided on the fan cover 8.

In this embodiment, as shown in FIG. 9, the blade holder 701 is provided with transmission external teeth 703. A lower end of the fan housing 6 is provided with a mounting groove 602. The wind energy conversion mechanism includes a transmission gear 15 and a generator 16. The transmission gear 15 is mounted on an input shaft of the generator 16, and is located on an upper surface of the circular plate of the fan housing 6. The transmission gear 15 is configured to mesh with the transmission external teeth 703. The generator 16 is located at a lower surface of the fan housing 6, and is mounted in the mounting groove 602. In addition, since the generator 16 has a relatively large size, an upper end of the second hub cover 3 is provided with a second accommodating cavity 302 for accommodating a lower portion of the generator 16. The generator 16 is electrically connected to the control mechanism. The control mechanism includes a main control circuit board 10, which is a conventional printed circuit board (PCB) provided with a microcontroller unit (MCU). When the blades 702 drive the blade holder 701 to rotate, the blade holder 701 drives the generator 16 to generate an electric current through meshing engagement between the transmission external teeth 703 and the transmission gear 15. The generated current is transmitted to the main control circuit board 10, and the MCU determines a magnitude of the current. When the current exceeds a predetermined threshold value (which may be set according to actual requirements), the main control circuit board 10 controls the driving motor 4 to release a portion of the electric pull cord 105, thereby closing the electric sunshade umbrella and preventing the electric sunshade umbrella from being overturned by strong wind.

In this embodiment, the main control circuit board 10 is detachably mounted on a side of the motor mounting bracket 41 away from the driving motor 4. Specifically, a plurality of threaded holes are provided on the side of the motor mounting bracket 41 away from the driving motor 4, and corresponding threaded holes are formed in the control circuit board 10, such that the main control circuit board 10 is detachably mounted on the second fixing plate 413 of the motor mounting bracket 41 by bolts.

### Embodiment 2

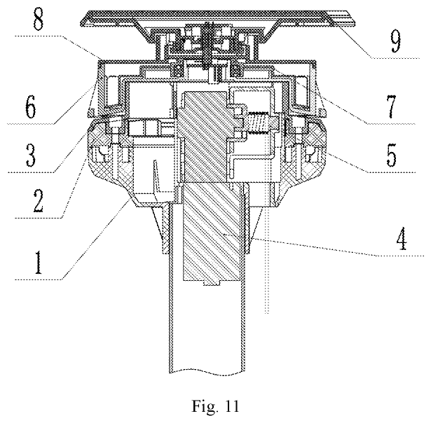

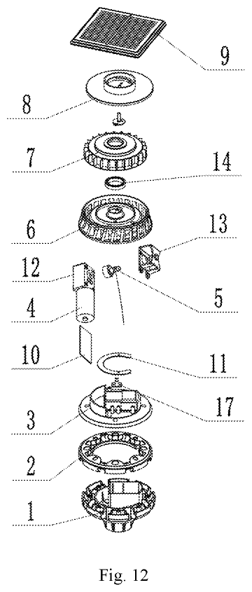

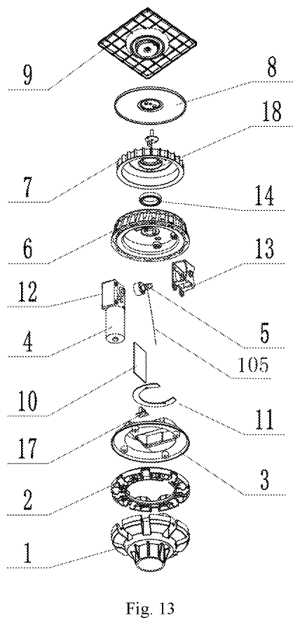

As shown in FIGS. 11-13, provided herein is an upper hub 100, and the technical features provided in this embodiment are substantially the same as those disclosed in Embodiment 1, except that the wind energy conversion mechanism is different.

In this embodiment, a lower end of the blade holder 701 is connected to a shielding plate 18. Specifically, three shielding plates 18 are provided. The three shielding plates 18 are circumferentially distributed at the lower end of the blade holder 701. The wind energy conversion mechanism includes a U-shaped photoelectric switch 17 (also referred to as a slot-type opposed photoelectric switch). The U-shaped photoelectric switch 17 may be mounted on the fan housing 6 or at other positions capable of interacting with the shielding plates 18. The shielding plates 18 are configured to rotate to pass through the U-shaped photoelectric switch 17. The U-shaped photoelectric switch 17 is electrically connected to the control mechanism.

When the blades 702 drive the blade holder 701 to rotate, the blade holder 701 drives the shielding plates 18 to rotate accordingly. When the shielding plates 18 pass through the U-shaped photoelectric switch 17, the shielding plates 18 block a light path of the U-shaped photoelectric switch 17, and the U-shaped photoelectric switch 17 transmits a trigger signal to the main control circuit board 10. When the trigger signal exceeds a predetermined threshold value (which may be set according to actual requirements), the main control circuit board 10 controls the driving motor 4 to release a portion of the electric pull cord 105, thereby closing the electric sunshade umbrella and preventing the electric sunshade umbrella from being overturned or damaged by strong wind.

### Embodiment 3

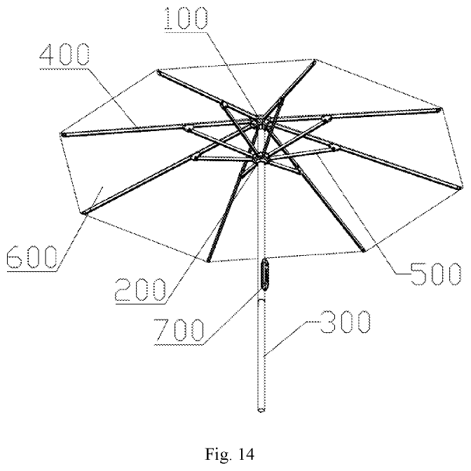

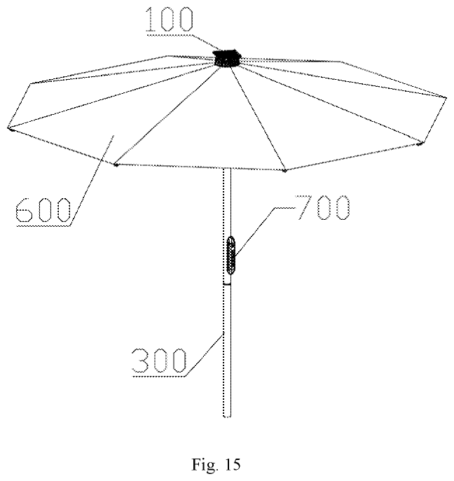

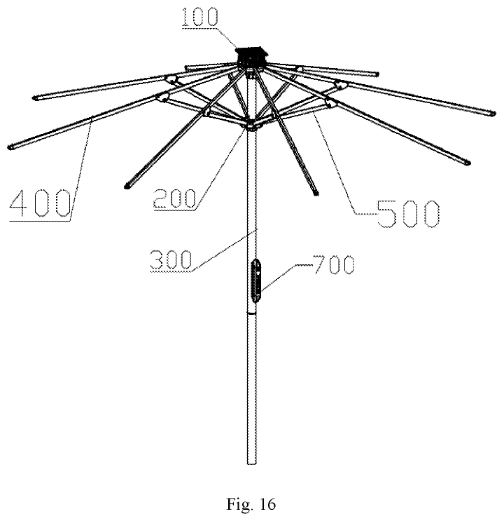

As shown in FIGS. 14-16, provided herein is an electric sunshade umbrella, which includes the upper hub 100 disclosed in Embodiment 1 or Embodiment 2.

In this embodiment, the electric sunshade umbrella further includes a lower hub 200, a pole 300, a plurality of first ribs 400, a plurality of second ribs 500, a canopy 600 and a control switch 700. The upper hub 100 is fixed to an upper end of the pole 300. Specifically, the upper end of the pole 300 is inserted into a lower end of the hub seat 1. A self-tapping screw is then inserted laterally through the hub seat 1 and the pole 300 to fix the upper hub 100 to the pole 300. The lower hub 200 is slidably connected to the pole 300. A center of the lower hub 200 is provided with a sixth through hole. The pole 300 is configured to pass through the sixth through hole, and is slidably connected to sixth through hole. The lower hub 200 is provided with a cord attachment. The second end of the electric pull cord 105 is connected to the cord attachment via a conventional lock buckle or U-shaped buckle structure, thereby achieving a detachable connection between the electric pull cord 105 and the cord attachment, although the electric pull cord 105 and the cord attachment are typically connected in practice. The number of the plurality of first ribs 400 is the same as the number of the plurality of second ribs 500. The plurality of first ribs 400 and the plurality of second ribs 500 are in a one-to-one positional correspondence. An end of each first rib 400 is hinged to the rib mounting gap 103 of the upper hub 100. A first end of each second rib 500 is hinged near a middle portion of a corresponding one of the first ribs 400, and a second end of each second rib 500 is hinged to a peripheral edge groove of the lower hub 200. The canopy 600 is mounted on the plurality of first ribs 400, and is jointly supported by upper surfaces of the first ribs 400. The control switch 700 is mounted on the pole 300, and is electrically connected to the control mechanism. The control switch 700 includes a motor start button. When the motor start button is pressed, the main control circuit board 10 controls the driving motor 4 to operate.

In this embodiment, the first rib 400 is provided with a lighting lamp. Correspondingly, the control mechanism further includes a lighting control circuit board 11. The control switch 700 further includes a lighting control button. The lighting lamp and the lighting control button are both electrically connected to the lighting control circuit board 11.

In practical use, a user only needs to press the lighting control button, and a control signal is transmitted to the lighting control circuit board 11, then the lighting control circuit board 11 controls the lighting lamp to be turned on or off.

In this embodiment, the pole 300 is provided with a first proximity switch and a second proximity switch. The first proximity switch is located above the second proximity switch. The first proximity switch and the second proximity switch are electrically connected to the main control circuit board 10. A to-be detected metal, such as an iron piece, is mounted on the lower hub 200. When the lower hub 200 moves to a position corresponding to the first proximity switch or the second proximity switch, the corresponding proximity switch detects a position signal of the lower hub 200 and transmits the position signal to the main control circuit board 10. When the lower hub 200 reaches a predetermined position, the main control circuit board 10 controls the driving motor 4 to stop.

In practical use, when the driving motor 4 rotates to drive the lower hub 200 to the position of the first proximity switch, the first proximity switch detects the to-be detected metal and transmits a position signal to the main control circuit board 10. The main control circuit board 10 then stops the driving motor 4. At this time, the canopy 600 is in a fully opened state. When the canopy 600 is to be retracted, the driving motor 4 rotates in reverse. When the lower hub 200 reaches the position of the second proximity switch, the second proximity switch detects the position signal of the to-be detected metal and transmits the signal to the main control circuit board 10. The main control circuit board 10 then stops the driving motor 4. At this time, the canopy 600 is in a retracted state.

In addition, an upper end of the pole 300 is provided with a limiting post. When the lower hub 200 moves to a highest position (at which the canopy 600 is fully opened), the lower hub 200 abuts against the limiting post, thereby limiting the movement of the lower hub 200 and preventing excessive travel.

Described above are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. An upper hub, comprising:
a hub body; and
a pull cord driving mechanism;
wherein a mounting cavity is provided within the hub body;
the pull cord driving mechanism is provided within the mounting cavity;
an output end of the pull cord driving mechanism is connected to a winding mechanism;
the pull cord driving mechanism is configured to drive the winding mechanism to rotate;
the hub body is provided with a first through hole; and
the winding mechanism is connected to a first end of an electric pull cord, and a second end of the electric pull cord is configured to pass through the first through hole.

2. The upper hub of claim 1, wherein the winding mechanism is a winding shaft; and an end of the winding shaft is connected to the output end of the pull cord driving mechanism.

3. The upper hub of claim 2, wherein the pull cord driving mechanism comprises a driving motor and a self-locking transmission mechanism;
an output shaft of the driving motor is connected to an input shaft of the self-locking transmission mechanism; and
an output shaft of the self-locking transmission mechanism is drivably connected to the winding shaft.

4. The upper hub of claim 3, further comprising:
a support fixing member;
wherein the support fixing member is mounted on a side of the self-locking transmission mechanism;
the support fixing member is provided with a limiting hole; and
an end of the winding shaft away from the self-locking transmission mechanism is rotatably connected to the limiting hole.

5. The upper hub of claim 3, wherein the hub body comprises a hub seat and a hub cover assembly; and the hub seat is fixedly connected to the hub cover assembly.

6. The upper hub of claim 5, wherein a plurality of housing portions are circumferentially arranged spaced apart on the hub seat, and are configured to protrude outwardly;
a rib mounting gap is formed between any two adjacent housing portions among the plurality of housing portions;
the rib mounting gap is configured for rotatable connection with a first rib;
two sides of each of the plurality of housing portions are each provided with a coil slot; and
a rib coil is jointly mounted on all coil slots;
a central portion of the hub seat is provided with an accommodating cavity; and
a lower end of the driving motor is inserted into the accommodating cavity.

7. The upper hub of claim 6, wherein the hub cover assembly comprises a first hub cover and a second hub cover;
the first hub cover is closer to the hub seat than the second hub cover;
a plurality of wire-passing holes are circumferentially arranged spaced apart on the first hub cover;
the second hub cover is provided with a second through hole and a third through hole;
the driving motor is configured to pass through the second through hole; and
the control mechanism is configured to pass through the third through hole.

8. The upper hub of claim 5, wherein an upper end of the hub cover assembly is provided with a wind force monitoring mechanism;
the wind force monitoring mechanism comprises a fan housing;
a plurality of ventilation holes are circumferentially arranged spaced apart at the fan housing;
an upper end of the fan housing is connected to a fan cover;
a fan is provided within the fan housing;
the fan comprises a blade holder;
the blade holder is rotatably connected to the fan housing;
a plurality of blades are circumferentially arranged spaced evenly apart on the blade holder; and
the fan is electrically connected to the control mechanism via a wind energy conversion mechanism.

9. The upper hub of claim 8, wherein an upper end of the wind force monitoring mechanism is provided with a solar photovoltaic assembly; and the solar photovoltaic assembly is electrically connected to the control mechanism.

10. The upper hub of claim 8, wherein the blade holder is provided with transmission external teeth; a lower end of the fan housing is provided with a mounting groove; the wind energy conversion mechanism comprises a transmission gear and a generator; the transmission gear is mounted on an input shaft of the generator; the transmission gear is configured to mesh with the transmission external teeth; and the generator is mounted in the mounting groove, and is electrically connected to the control mechanism; or
the blade holder is connected to a shielding plate; the wind energy conversion mechanism comprises a U-shaped photoelectric switch; the shielding plate is configured to rotate to pass through the U-shaped photoelectric switch; and the U-shaped photoelectric switch is electrically connected to the control mechanism.

11. The upper hub of claim 1, wherein the winding mechanism is a winch; and a first side of the winch is connected to the output end of the pull cord driving mechanism.

12. The upper hub of claim 11, wherein the first side of the winch is provided with an insertion hole; and the output end of the pull cord driving mechanism is inserted into the insertion hole.

13. The upper hub of claim 12, wherein the output end of the pull cord driving mechanism is in a form-fit connection with the insertion hole.

14. The upper hub of claim 11, further comprising:
a support fixing member;
wherein the support fixing member is provided with a limiting hole; and
a second side of the winch is configured to partially extend into the limiting hole.

15. The upper hub of claim 14, wherein a washer is provided in the limiting hole; and the washer is configured to rotatably abut against the second side of the winch.

16. The upper hub of claim 11, wherein the winch is provided with a fastening hole; and the fastening hole is connected to the first end of the electric pull cord.

17. The upper hub of claim 8, wherein a central portion of the fan housing is provided with a mounting ring; a bearing is sleeved on the mounting ring; and the fan is rotatably mounted on the mounting ring via the bearing.

18. The upper hub of claim 17, wherein the wind energy conversion mechanism comprises a magnetic member and a sensor;
the magnetic member is provided on the fan; and
the sensor is arranged opposite to the magnetic member in a vertical direction.

19. The upper hub of claim 18, wherein the sensor is mounted on the hub cover assembly via a mounting plate.

20. An electric sunshade umbrella, comprising:
the upper hub of claim 1;
a lower hub;
a pole;
a plurality of first ribs;
a plurality of second ribs;
a canopy; and
a control switch;
wherein the upper hub is fixed to an upper end of the pole;
the lower hub is slidably connected to the pole;
the lower hub is provided with a cord attachment;
the second end of the electric pull cord is connected to the cord attachment;
the number of the plurality of first ribs is the same as the number of the plurality of second ribs;
an end of each of the plurality of first ribs is hinged to the upper hub;
a first end of each of the plurality of second ribs is hinged to a corresponding one the plurality of first ribs, and a second end of each of the plurality of second ribs is hinged to the lower hub;
the canopy is mounted on the plurality of the first ribs; and
the control switch is mounted to the pole, and is electrically connected to the control mechanism.
